(19) United States
(12) Patent Application Publication
(10) Pub. No.: US 2013/0016673 A1
(43) Pub. Date: Jan. 17, 2013

(54) APPARATUS AND METHOD FOR ASSIGNING MULTICARRIER IN WIRELESS ACCESS SYSTEM

(71) Applicants: Jeongki Kim, Anyang (KR); Youngsoo Yuk, Anyang (KR)

(72) Inventors: Jeongki Kim, Anyang (KR); Youngsoo Yuk, Anyang (KR)

(73) Assignee: LG ELECTRONICS INC., Seoul (KR)

(21) Appl. No.: 13/520,977

(22) PCT Filed: Dec. 29, 2010
(86) PCT No.: PCT/KR10/09524

§ 371 Date: Aug. 31, 2012

Related U.S. Application Data
(60) Provisional application No. 61/309,398, filed on Mar. 1, 2010.

(30) Foreign Application Priority Data
Nov. 9, 2010 (KR) 10-2010-0111176

(51) Int. Cl. H04W 72/04

(52) U.S. Cl. 370/329

(57) ABSTRACT

Disclosed is a method for operating a terminal for assigning multicarrier in a wireless access system, the method including receiving a multicarrier advertisement message from a base station, the multicarrier advertisement message including multicarrier configuration information supported by the base station, determining simultaneously available carriers based upon the multicarrier configuration information, sending a first message to the base station, the first message including information indicating whether or not all the carriers supported by the base station are simultaneously available, and receiving a second message from the base station, the second message including information indicating whether or not all the carriers requested by the terminal via the first message are assigned.

### TECHNICAL FIELD

This specification relates to a method and apparatus for assigning multicarrier, and more particularly, a method and apparatus by which a terminal requests a multicarrier allocation or a base station assigns the multicarrier to the terminal.

### BACKGROUND ART

Multicarrier System

IEEE 802.16m system, one of wireless communication systems, classifies carriers into two types from the perspective of a base station. For example, the types of carriers may include a fully configured-carrier type (FCCT) and a partially configured carrier type (PCCT).

The FCCT indicates a carrier by which every control information and data can be sent or received, and the PCCT indicates a carrier by which only downlink (DL) data can be sent or received. Here, the PCCT may be used for services, such as an enhanced multicast broadcast service (E-MBS), which usually provides DL data.

From the perspective of a mobile terminal, assigned carriers may be divided into two types, for example, a primary carrier type and a secondary carrier type. Here, the mobile terminal may be allocated with one primary carrier and a plurality of subcarriers from the base station.

The primary carrier may be selected from the fully configured carriers. Most of essential control information related to the mobile terminal may be sent on the primary carrier. The subcarriers may be selected from the fully configured carriers or the partially configured carriers, and also additionally allocated in response to request of the mobile terminal or instruction of the base station.

The mobile terminal may send and receive not only every control information but also control information related to the subcarriers over the primary carrier, and exchange (transceiver) data with the base station over the subcarriers. Here, the subcarrier, as a fully configured carrier, allocated to a specific mobile terminal, may be set to a primary carrier of another mobile terminal.

Also, in the exemplary embodiments described herein, the number of carriers used in downlink may not be equal to the number of carriers used in uplink. That is, the type and number of carriers to be actually available (available to be used) may differ according to characteristics of multicarrier supported by the base station and the mobile terminal. In addition, a carrier using method may differ according to a current quality of service (QoS) of the mobile terminal or a load condition of the base station.

Multicarrier may be divided into an available carrier set and an assigned carrier set according to the using method thereof. The available carrier set indicates a set of every carriers existing in the base station, and the assigned carrier set indicates a set of carriers actually assigned to a specific mobile terminal. Here, the assigned carrier set may be a part or all of the available carrier set.

The base station may send information related to the available carrier set to a mobile terminal via a specific broadcast channel. Multicarrier information may be similar to co-located frequency assignment (FA) information, which is sent for an inter-frequency handover in the existing system (e.g., IEEE 802.16e), so it can be sent via a neighboring base station advertisement (AAI_NBRADV) message. Alternatively, the multicarrier information may be sent via an additional message for sending multicarrier configuration information.

The mobile terminal may receive multicarrier information at the beginning of entering a network. If failed to receive the information, the mobile terminal may keep using a carrier assigned thereto without use of the multicarrier information.

For supporting multicarrier transmission, the mobile terminal and the base station may exchange parameters associated with performances of the multicarrier.

This process is generally performed during the process of entering a network or a similar level process (e.g., registration process, initial ranging process or basic ability negotiation process).

The base station may assign the primary carrier and the subcarriers to the mobile terminal according to the multicarrier performance parameters exchanged with the mobile terminal and the current load condition of the base station. In general, the primary carrier may be a carrier which performs the network entry. However, the base station may assign another full configured carrier as the primary carrier for distribution of the primary carrier.

Thus, the carriers, which the base station assigns to a specific mobile terminal, indicate assigned carriers, and the assigned carrier set is maintained until being updated for a certain reason. Although the assigned carrier set is assigned to a mobile terminal, all of the carriers assigned to the mobile terminal may not always be used. That is, all or part of the assigned carrier set may be used for actual data transmission, and the carriers used for the actual data transmission is referred to as active carriers.

Here, the primary carrier may be always an active carrier, and the subcarrier may operate either as an active carrier or as an in-active carrier depending on an instruction of the base station.

The assigned carriers may be assigned in relation to radio frequency capabilities of the mobile terminal and the base station, and whether to use the active carriers may be decided according to current service requirements of the mobile terminal. The in-active carriers may be turned off for power saving. Transmission of associated control channels is not required for the turned-off carriers, thereby reducing overhead of a network.

Hereinafter, a message, which is required to perform a procedure that a terminal is assigned with multicarrier from the base station, will be briefly described.

Global Carrier Configuration Message (AAI_Global_Config Message)

Table 1 shows an example of a format of a global carrier configuration message (AAI_Global_Config message).

TABLE 1

| | Size | |
|---|---|---|
| Field | (Bit) | Notes |
| MAC Control Message Type | 8 | |
| Number of Carrier Groups | 4 | Groups of |
| | | contiguous Carriers |
| For(i=0; i<Number of Carrier Groups; | | |
| i++){ | | |
| Multi-Carrier Configuration Index | 6 | Index associated to MC |
| Across the Network | | |
| Start Frequency Assignment Index | 6 | Frequency Assignment |
| | | Index of the first |
| | | carrier in carrier group #i |
| Number of Carriers | 6 | |
| For(j=0; i<Number of Carriers: j++){ | | |
| Physical Carrier Index | 6 | Index of the physical |
| | | carrier |
| Duplexing Mode | 1 | “0” for TDD |
| | | “1” for FDD |
| } | | |
| } | | |
| Physical Carrier Index of Current | 6 | The carrier that |
| Carrier | | broadcasts this message; |
| | | the physical carrier index |
| | | refers to AAI_Global- |
| | | Config message |

Referring to Table 1, the global carrier configuration message may include a MAC control message type field indicating a type of the corresponding message, a field indicating the number of carrier groups of a network (i.e., number of carrier groups field), and information related to physical carrier index of a current carrier.

Here, the global carrier configuration message may further include multicarrier configuration index across the network, start frequency assignment index, a field of the number of carriers, physical carrier index and duplexing mode field indicating a duplexing type of the corresponding network.

Multicarrier Advertisement Message (AAI_MC-ADV Message)

Table 2 shows an example of a format of a multicarrier advertisement message (AAI_MC-ADV message).

TABLE 2

| | size | |
|---|---|---|
| Field | (Bit) | Notes |
| MAC Control Message Type | 8 | |
| Multicarrier configuration | 4 | Incremented by 1 upon each |
| change count | | update. |
| Serving BS Carrier Number | 3 | |
| Serving BS Uniformity Flag | 1 | 0: All carriers supported by |
| | | serving ABS have the same |
| | | Protocol Version, SFH_Info |
| | | 1: otherwise |
| Physical Carrier Index of | 6 | The carrier that ABS broadcast |
| current carrier | | this message: the physical |
| | | carrier index refers to |
| | | AAI_Global-Config Message. |
| MAC Protocol Version | 8 | Consistent with REV.2 definition, |
| | | with new MAC protocol |
| | | version 9 defined for 16m |
| For(i=1; i<= serving BS | | |
| carrier Number−1: i++){ | | |
| Physical Carrier Index | 6 | // Physical carrier index in |
| | | AAI_Global-Config message |
| SA-Preamble Index | 10 | |
| — | — | — |
| — | — | — |

As shown in Table 2, the AAI_MC-ADV message may include a multicarrier configuration (MC) change count parameter, which increases by 1 every time when a multicarrier configuration of the base station changes, a serving BS carrier number field indicating the number of carriers handled by a serving base station, a serving BS uniformity flag indicating a protocol version of carriers supported by the serving base station, a physical carrier index field indicating physical carrier index of a current carrier, a MAC protocol version parameter indicating MAC protocol version defined for 16m system, and a physical carrier index parameter indicating physical carrier indexes of assigned carriers supported by the base station.

Also, the AAI_MC-ADV message may further include information related to SA preamble sent by the base station.

Multicarrier Request Message (AAI_MC-REQ Message)

Table 3 shows an example of a format of a multicarrier request message (AAI_MC-REQ message).

TABLE 3

| | Size | |
|---|---|---|
| Fields | (bits) | Notes |
| Availability flag | 1 | |
| If(availability flag=0){ | | |
| N_Candidate_sets | 2 | The number of candidates of carrier |
| | | set that the terminal can receive |
| for(i=0); | | |
| i<N_Candidate_sets;i++){ | | |
| No. of MC | 4 | The number of carriers that the |
| | | terminal can use |
| for(i=0;i<No. of MC;i++){ | | |
| Carrier Index | 6 | Available or preferred carrier |
| | | indexes among carrier index |
| | | information of the base station |
| } | | |
| } | | |

As shown in Table 3, the AAI_MC-REQ message may include a MAC control message type field indicating a type of a current message, candidate set number field indicating the number of candidate sets, a candidate assigned carrier number field, a physical carrier index field indicating carriers simultaneously supportable by AMS, and a field indicating support of data transmission over guard subcarrier.

For reduction of message overhead, if the carrier indexes supported by the terminal are the same as the carrier indexes supported by the base station, the terminal may inform it to the base station. Here, the terminal, as shown in Table 3, may set an availability flag to ‘1,’ thereby not including carrier index information in the AAI_MC-REQ message.

As described above, if the availability flag within the MC-REQ message sent from the terminal to the base station is set to ‘1,’ the MC-REQ message may include information related to type, availability flag, and support of data transmission over guard subcarrier, and sending less information using the message may cause overhead (due to MAC header, CRC, security information and the like).

Upon reception of the MC-REQ message from the terminal, the base station sends MC-RSP message to the terminal, in response to the MC-REQ message, by including carrier indexes, which are to be used by the terminal, in order to assign carriers to the terminal. However, since the terminal has already acquired every physical carrier index information supported by the base station via the MC-ADV message, when including all of the physical carrier indexes in the MC-RSP message, it may cause an unnecessary message overhead.

### DISCLOSURE OF INVENTION

### Solution to Problem

Therefore, to address the above-mentioned problem, an aspect of the detailed description is to provide a method for assigning multicarrier when a base station supports a multicarrier system, in a wireless access system.

Especially, an aspect of the detailed description is to provide an efficient request or assignment method and apparatus in case where a terminal requests a carrier assignment from a base station or the base station assigns carriers to the terminal in response to the request.

To achieve these and other advantages and in accordance with the purpose of the present invention, as embodied and broadly described herein, there is provided a multicarrier assignment method in the perspective of a terminal in a wireless access system, the method including receiving a multicarrier advertisement message from a base station, the multicarrier advertisement message including multicarrier configuration information supported by the base station, determining simultaneously available carriers based upon the multicarrier configuration information, sending a first message to the base station, the first message including information indicating whether or not all the carriers supported by the base station are simultaneously available, and receiving a second message from the base station, the second message including information indicating whether or not all the carriers requested by the terminal via the first message are assigned.

In one aspect, the first message may be a multicarrier request message (MC-REQ message).

In another aspect, the first message may be either a multicarrier request extended header (MC-REQ extended header) or a multicarrier request signaling header (MC-RSP signaling header).

In another aspect, the first message may be sent to the base station when all the carriers supported by the base station are simultaneously available.

In another aspect, the first message may further include a field indicating the number of candidate assigned carriers, and a physical carrier index field indicating the candidate assigned carriers.

In another aspect, the first message may not include physical carrier indexes indicating carriers supported by the base station when all the carriers supported by the base station are simultaneously available.

In another aspect, the second message may be a multicarrier response message (MC-RSP message).

In another aspect, the second message may be either a multicarrier response extended header (MC-RSP extended header) or a multicarrier response signaling header.

In another aspect, the second message may be sent to the terminal when all the carriers requested by the terminal via the first message are assigned to the terminal.

In another aspect, the second message may further include a field indicating the number of assigned carriers, assigned to the terminal, and a physical carrier index field indicating the assigned carriers.

In another aspect, the second message may not include physical carrier indexes of the assigned carriers when all the carriers requested by the terminal via the first message are assigned to the terminal.

In another aspect, the multicarrier configuration information may include physical carrier indexes of the carriers supported by the base station.

In another aspect, the method may further include receiving a global carrier configuration message (Global-CFG message) from the base station, the global carrier configuration message including information related to all the available carriers across a network, to which the base station belongs.

In another aspect, the information indicating whether or not all the carriers requested by the terminal are assigned may be a global assign field.

In one aspect of one exemplary embodiment, a terminal apparatus for multicarrier assignment in a wireless access system may include a wireless communication unit configured to receive a multicarrier advertisement message from a base station, the multicarrier advertisement message including information related to multicarrier configuration supported by the base station, and a controller configured to control the wireless communication unit to decide carriers simultaneously available in the terminal based upon the multicarrier configuration information, send a first message to the base station to request for carrier assignment, and receive a second message, including information related to carriers assigned to the terminal, from the base station.

In one aspect, the first message is one of a multicarrier request message, a multicarrier request extended header or a multicarrier request signaling header.

This specification can have effects of reducing an overhead of a multicarrier message sent from the terminal or the base station by virtue of an efficient multicarrier assignment method, and accordingly increasing resource efficiencies by minimizing resources consumed upon message transmission.

### BRIEF DESCRIPTION OF DRAWINGS

FIG. 1 is a flowchart showing a multicarrier assignment procedure in accordance with one exemplary embodiment;

FIG. 2 is a flowchart showing a multicarrier assignment method in accordance with a first exemplary embodiment;

FIG. 3 is a flowchart showing a case where a second message shown in FIG. 2 is MC-RSP extended header or MC-RSP signaling header;

FIG. 4 is a flowchart showing a multicarrier assignment method in accordance with a second exemplary embodiment;

FIG. 5 is a flowchart showing a case where a second message shown in FIG. 4 is MC-RSP extended header or MC-RSP signaling header; and

FIG. 6 is an internal block diagram showing a terminal in accordance with one exemplary embodiment.

### MODE FOR THE INVENTION

Reference will now be made in detail to the preferred embodiments of the present invention, examples of which are illustrated in the accompanying drawings. It should be understood that the description herein will be given of essential parts required to understand operations according to this specification and description of the other parts will be omitted to obviate obscurity of the point of the invention.

The exemplary embodiments herein are combinations of components and characteristics in certain forms. Each component or characteristic should be considered to be optional unless being explicitly described. Each component or characteristic may be embodied in the form of non-combination with other components or characteristics. Also, the exemplary embodiments can be implemented by combination of part of components and/or characteristics. The sequence of operations described in the exemplary embodiments may differ. Part of configurations or characteristics in one exemplary embodiment will be included in another exemplary embodiment, or be replaced with corresponding configurations or characteristics in another embodiment.

The exemplary embodiments in this specification are described herein on the basis of relation of data transmission and reception between a base station and a terminal. Here, the base station may indicate a terminal node of a network, which performs communications directly with the terminal. Specific operations, which will be described as being performed by the base station in this specification, may be performed by an upper node of the base station.

That is, it is obvious that in a network comprising a plurality of network nodes including the base station, various operations performed for communications with the terminal can be performed by the base station or different network nodes other than the base station. ‘Base station’ will be replaced with other terms, such as a fixed station, Node B, eNode B (eNB), access point and the like. Also, ‘terminal’ may be replaced with other terms, such as user equipment (UE), mobile station (MS), mobile subscriber station (MSS) and the like.

The exemplary embodiment described herein may be embodied by various means. For example, the exemplary embodiments may be implemented by hardware, firmware, software, or combination of them.

For a hardware implementation, the embodiments described herein may be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, micro processors.

For firmware or software implementation, the method according the exemplary embodiments described herein may be implemented in the form of module, procedure, function or the like, which performs functions or operations described above. Software codes may be stored in a memory unit to be operated by a processor. The memory unit may be present inside or outside the processor, to exchange (transceiver) data with the processor via various means, which have been already known.

Specific terms used in the following description are provided for better understanding of the specification, and use of such terms may be changed into different forms within the scope of this invention.

Hereinafter, description will be given of a method, by which a terminal requests a multicarrier from a base station and the base station assigns the multicarrier to the terminal, in a multicarrier supporting system.

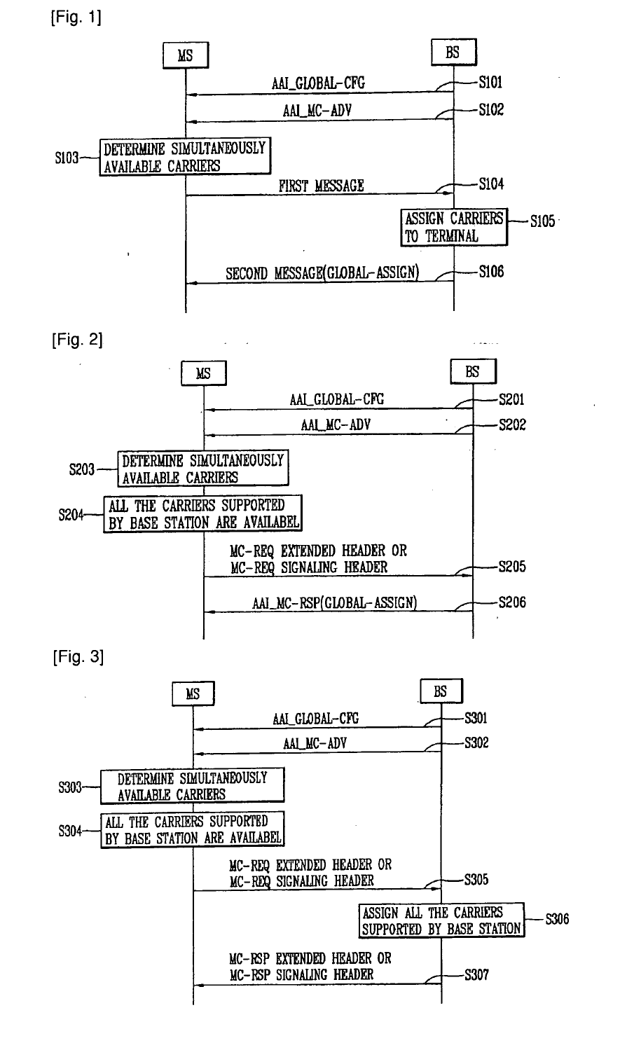

FIG. 1 is a flowchart showing a multicarrier assignment procedure in accordance with one exemplary embodiment.

First, a base station may send a global carrier configuration message (AAI_Global_Config message) to a mobile terminal by including carrier information related to all available carriers across a network, to which the base station belongs (S101). The step of sending the AAI_Global_Config message by the base station may be performed immediately after the terminal completes a network entry procedure.

Here, the carrier information may include a field indicating the number of carrier groups, a multicarrier index (MCI) field indicating a multicarrier configuration and a physical carrier index (PCI) field indicating physical carrier indexes for all the available carriers.

The base station may then periodically broadcast to the terminal a multicarrier advertisement message (AAI_MC-ADV message) including information related to a multicarrier configuration supported by the base station (S102).

Here, the information related to the multicarrier configuration may include information related to assigned carriers, assigned from the base station to the terminal. The information related to the assigned carriers may include a field indicating the number of assigned carriers, assigned to the terminal, and a physical carrier index field indicating the assigned carriers assigned to the terminal.

Next, the terminal may decide simultaneously available carriers based upon the multicarrier configuration information included in the AAI_MC-ADV message sent by the base station (S103). Here, the terminal may decide the simultaneously available carriers according to hardware capabilities thereof. Also, the terminal may decide a subset of the simultaneously available carriers.

The terminal may then send a first message to the base station by including information indicating whether or not all of the carriers supported by the base station are available at the same time (S104).

That is, the terminal may inform the base station of the information related to the simultaneously available carriers of all the carriers supported by the base station via the first message. The simultaneous use of all the carriers supported by the base station means that the terminal can process all the carriers at the same time.

Here, the first message may be a multicarrier request message (AAI_MC-REQ message) sent from the terminal to the base station to request for carrier assignment.

Also, the first message may be a multicarrier request extended header (MC-REQ Extended Header) or a multicarrier request signaling header (MC-REQ Signaling Header).

Here, the MC-REQ extended header or the MC-REQ signaling header may be sent to the base station when the terminal can use all the carriers supported by the base station.

Also, the MC-REQ extended header may be used when the terminal has a packet data unit (PDU) to send to the base station.

Hereinafter, a multicarrier assignment method according to the type of the first message will be described in detail with reference to the exemplary embodiments.

The base station may assign carriers to the terminal with respect to the carriers, which have been requested by the terminal or sent via the first message (S105). Here, the base station may assign all or part of the carriers to the terminal.

The terminal may receive a second message including information related to the assigned carriers from base station (S106).

The second message may include information indicating whether or not all the carriers requested by the terminal via the first message are assigned. The information may be a global assign field.

Here, the second message may be a multicarrier response message (AAI_MC-RSP message).

Also, the second message may be a multicarrier response extended header (MC-RSP Extended Header) or a multicarrier response signaling header (MC-RSP Signaling Header). Here, the MC-RSP extended header or the MC-RSP signaling header may be sent to the terminal when the base station assigns all the carriers requested by the terminal.

Also, the MC-RSP extended header may be used when the base station has a PDU to send to the terminal.

Hereinafter, a multicarrier assignment method according to the type of the second message will be described in detail with reference to the exemplary embodiments.

The terminal can use the carriers assigned from the base station via the second message, to exchange data with the base station.

### First Exemplary Embodiment

The first exemplary embodiment illustrates a method of informing that the terminal can use all the carriers supported by the base station, namely, a method of using MC-REQ extended header and the MC-REQ signaling header.

FIG. 2 is a flowchart showing a multi-carrier assignment method in accordance with a first exemplary embodiment.

Steps S201 to S203 are the same as the steps S101 to S103, so description thereof will be omitted excluding different parts.

At step S203, if the terminal can simultaneously use all the carriers supported by the base station, the terminal may send a first message to the base station.

Here, the first message may be MC-REQ extended header or the MC-REQ signaling header. Here, if the terminal sends the MC-REQ extended header, the terminal may send the same together with PDU.

That is, when the base station receives the MC-REQ extended header or the MC-REQ signaling header from the terminal, the base station may determine that the terminal can use all the carriers supported thereby.

Table 4 as follows shows an example of MC-REQ extended header format.

TABLE 4

| Syntax | Size (bits) | Notes |
|---|---|---|
| MC-REQ extended header ( ) { | | |
| Type | 4 | MC-REQ extended header |
| Support of data transmission | 1 | |
| over guard sub-carrier | | |
| Reserved | 3 | |

Table 5 as follows shows an example of MC-REQ signaling header format.

TABLE 5

| Syntax | Size (bits) | Notes |
|---|---|---|
| MC-REQ signaling header ( ) { | | |
| FID | 4 | Signaling header |
| Type | 4 | MC-REQ signaling header |
| Support of data transmission | 1 | |
| over guard sub-carrier | | |
| Reserved | 39 | |

At step S206, the base station may send to the terminal a second message including information related to carriers, assigned to the terminal. Here, the second message may be a multicarrier response message (AAI_MC-RSP message).

The MC-RSP message may include a global assign field indicating whether the carriers sent via the first message are all assigned.

As one example, if the global assign field is set to ‘1,’ it indicates that the carriers sent via the first message are all assigned. In this case, the base station may not include information related to each carrier, namely, physical carrier indexes, in the MC-RSP message.

If the global assign field is set to ‘0,’ it indicates that part of the carriers sent by the first message is assigned. In this case, the base station may include information related to the assigned carriers in the MS-RSP message so as to send the MS-RSP message to the terminal. The information may include physical carrier indexes.

For example, assuming that the physical carrier indexes of the carriers supported by the base station are 1, 2, 3, 4 and 5, if the base station assigns the physical carriers indexes 2 and 3 to the terminal, the base station sets the global assign field to ‘0’ so as to inform the terminal of the physical carrier indexes 2 and 3.

Also, assuming that the base station assigns all the physical carrier indexes 1, 2, 3, 4 and 5 to the terminal, the global assign field is set to ‘1’ and any physical carrier index is not explicitly included in the MC-RSP message.

Table 6 as follows shows an example of AAI_MC-RSP message.

TABLE 6

| | Size | |
|---|---|---|
| Syntax | (bit) | Notes |
| MAC Control Message Type | | |
| Global assign | 1 | Carrier assignment indicator. |
| | | Indicates whether the ABS |
| | | assigns all the carriers |
| | | requested by AMS through |
| | | AAI-MC-REQ |
| | | 0b0: The ABS assigns a subset |
| | | of the carriers requested by |
| | | AMS |
| | | 0b1: The ABS assigns all the |
| | | carriers requested by AMS |
| If (Global assign == 0b0) { | | |
| Number of Candidate Assigned | 3 | |
| Carrier (Nc) | | |
| For (i=0 ; i<Nc;i++) { | | |
| Physical Carrier Index | 6 | The carriers AMS can |
| | | simultaneously support |
| Support of data transmission | 1 | 0b0 = Not supported |
| over guard sub-carrier | | 0b1 = support |
| } | | |
| } | | |

FIG. 3 is a flowchart showing a case where the second message shown in FIG. 2 is MC-RSP extended header or MC-RSP signaling header.

Steps S301 to S305 are the same as the steps S201 to S205, so description thereof will be omitted excluding different parts.

When the base station assigns all the carriers sent via the first message to the terminal, namely, the base station assigns all the carriers supported thereby to the terminal (S306), the base station may send a second message to the terminal (S307).

Here, the second message may be MC-RSP extended header or the MC-RSP signaling header.

The MC-RSP extended header may be sent to the terminal together with PDU.

Table 7 as follows shows an example of MC-RSP extended header.

TABLE 7

| Syntax | Size (bit) | Notes |
|---|---|---|
| MC-RSP | | |
| extended | | |
| header ( ) { | | |
| Type | 4 | MC-RSP extended header |
| Guard | Variable | Whether or not data transmission is available |
| sub-carrier | | in guide subcarriers of all the candidate |
| support bitmap | | assigned carriers requested by the terminal |
| | | is indicated using a bitmap. |
| | | Therefore, the size of the bitmap is the same |
| | | as the number of candidate assigned carriers |
| | | requested by the terminal. |
| Reserved | Variable | |

Table 8 as follows shows an example of MC-RSP signaling header.

TABLE 8

| | Size | |
|---|---|---|
| Syntax | (bit) | Notes |
| MC-RSP | | |
| signaling | | |
| header ( ) { | | |
| FID | 4 | Signaling header |
| Type | 4 | MC-RSP signaling header |
| Guard sub-carrier | variable | Whether or not data transmission is available |
| support bitmap | | in guide subcarriers of all the candidate |
| | | assigned carriers requested by the terminal |
| | | is indicated using a bitmap. |
| | | Therefore, the size of the bitmap is the same |
| | | as the number of candidate assigned carriers |
| | | requested by the terminal. |
| Reserved | variable | |

Therefore, upon reception of the second message, the terminal may determine that the base station has assigned all the carriers, thereby exchanging data with the base station using the assigned carriers.

### Second Exemplary Embodiment

The second exemplary embodiment illustrates assigning multicarrier to the terminal using candidate set information related to physical carrier indexes requested by the terminal.

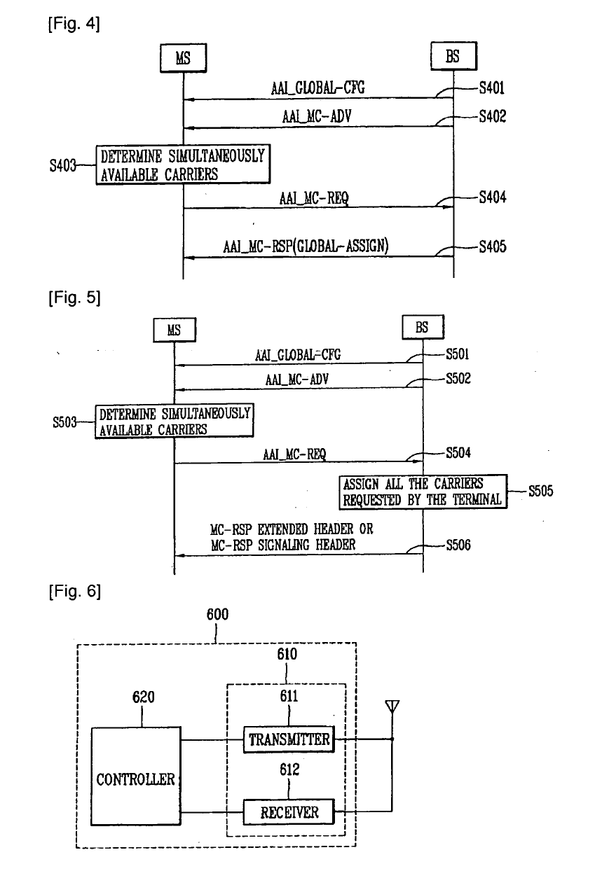

FIG. 4 is a flowchart showing a multi-carrier assignment method in accordance with a second exemplary embodiment.

Steps S401 to S403 are the same as the steps S101 to S103, so description thereof will be omitted excluding different parts.

The terminal may send a first message to the base station to request for assignment of carriers supported by the base station (S404).

Here, the first message may be a multicarrier request message (AAI_MC-REQ message), which the terminal sends to the base station to request for the carrier assignment.

As aforesaid, the first message may include a field (i.e., global support field) for indicating whether or not the carriers supported by the base station are simultaneously available.

Also, the MC-REQ message may further include a field indicating the number of candidate assigned carriers which the terminal is simultaneously available, and a physical carrier index field indicating the candidate assigned carriers.

That is, the terminal requests the base station to assign the carriers via the MC-REQ message.

Next, the base station may send to the terminal a second message including information related to the assigned carriers, assigned to the terminal, in response to the MC-REQ message (S405). Here, the second message may be a multicarrier response message (MC-RSP message).

The MC-RSP message may include a field (i.e., global assign field) indicating whether or not all the carriers requested by the terminal are assigned. One example of the MC-RSP message format will be understood with reference to Table 6.

As one example, if the global assign field within the MC-RSP message is set to ‘1,’ it indicates that all the terminal-requested carriers have been assigned to the terminal. Here, the AAI_MC-RSP message may not include physical carrier index information assigned to the terminal.

If the global assign field is set to ‘0,’ it indicates that part of the terminal-requested carriers has been assigned to the terminal.

For example, assuming that the physical carrier indexes of the carriers supported by the base station are 1, 2, 3, 4 and 5, when the terminal requests the physical carrier indexes 2, 3 and 4 from the base station via the MC-REQ message, if the base station assigns the physical carrier indexes 2 and 3 to the terminal, the base station sets the global assign field ‘0’ and informs the terminal of the physical carrier indexes of 2 and 3.

If the base station assigns all of the physical carrier indexes 2, 3 and 4 to the terminal, the base station sets the global assign field to ‘1’ and may not explicitly include the physical carrier indexes in the MC-REQ message.

FIG. 5 is a flowchart showing a case where the second message shown in FIG. 4 is MC-RSP extended header or MC-RSP signaling header.

Steps S501 to S504 are the same as the steps S401 to S404, so description thereof will be omitted excluding different parts.

If the base station assigns to the terminal all the carriers requested by the terminal via the MC-REQ message (S505), the base station may send a second message to the terminal (S506).

Here, the second message may be a MC-RSP extended header or MC-RSP signaling header. The examples of the MC-RSP extended header and MC-RSP signaling header formats will be understood with reference to the aforesaid Tables 7 and 8.

The MC-RSP extended header may be sent to the terminal together with a PDU.

That is, if the terminal receives the MC-RSP extended header or MC-RSP signaling header, the terminal may determine that the base station assigns all the candidate assigned carriers requested, and accordingly exchange data with the base station using the assigned carriers.

FIG. 6 is an internal block diagram showing a terminal in accordance with one exemplary embodiment.

A terminal 600 may include a wireless communication unit 610 and a controller 620.

First, the wireless communication unit 610 may include a transmitter 611 and a receiver 612.

The wireless communication unit 610 may receive a multicarrier advertisement message, including multicarrier configuration information supported by the base station, via the receiver. Here, the multicarrier configuration information may include physical carrier indexes of carriers supported by the base station.

Also, the wireless communication unit 610 may receive a global carrier configuration message (Global-CFG message), including information related to all the available carriers across a network, to which the base station belongs, from the base station.

The controller 620 may control the wireless communication unit 610 to decide carriers, which the terminal can simultaneously use, based upon the multicarrier configuration information received, send a first message to the base station to request for carrier assignment, and receive a second message including information related to the carriers, which the base station has assigned to the terminal.

Here, the first message may be one of a multicarrier request message, a multicarrier request extended header or a multicarrier request signaling header.

The first message may include information indicating whether or not carriers supported by the base station are all available, namely, include a global assign field.

The second message may be a multicarrier response message, a multicarrier response extended header or a multicarrier response signaling header.

The second message may include information indicating whether or not terminal-requested carriers have all been assigned, namely, include a global assign field.

1. A method for operating a terminal for assigning multicarrier in a wireless access system, the method comprising:
receiving from a base station, a multicarrier advertisement message, including multicarrier configuration information supported by the base station;
determining simultaneously available carriers based upon the multicarrier configuration information;
sending, to the base station, a first message including information indicating whether or not all the carriers supported by the base station are simultaneously available; and
receiving, from the base station, a second message including information indicating whether or not all-the carriers requested by the terminal via the first message are assigned.

2. The method of claim 1, wherein the first message is a multicarrier request message.

3. The method of claim 1, wherein the first message is a multicarrier request extended header or a multicarrier request signaling header.

4. The method of claim 3, wherein the first message is sent to the base station when all the carriers supported by the base station are simultaneously available.

5. The method of claim 2, wherein the first message further comprises a field indicating the number of candidate assigned carriers, and a physical carrier index field indicating the candidate assigned carriers.

6. The method of claim 2, wherein the first message does not comprise physical carrier index indicating one or more carrier supported by the base station when all the carriers supported by the base station are simultaneously available.

7. The method of claim 1, wherein the second message is a multicarrier response message.

8. The method of claim 1, wherein the second message is a multicarrier response extended header or a multicarrier response signaling header.

9. The method of claim 8, wherein the second message is sent to the terminal when all the carriers requested by the terminal via the first message are assigned to the terminal.

10. The method of claim 7, wherein the second message further comprises a field indicating the number of assigned carriers, assigned to the terminal, and a physical carrier index field indicating the assigned carriers.

11. The method of claim 7, wherein the second message does not comprise physical carrier index of the assigned carriers when all the carriers requested by the terminal via the first message are assigned to the terminal.

12. The method of claim 1, wherein the multicarrier configuration information comprises physical carrier index of the carriers supported by the base station.

13. The method of claim 1, further comprising receiving, from the base station, a global carrier configuration message including information related to all the available carriers in a network, to which the base station belongs.

14. The method of claim 1, wherein the information indicating whether or not all the carriers requested by the terminal are assigned is a global assign field.

15. A terminal apparatus for multicarrier assignment in a wireless access system, the device comprising:
a wireless communication unit configured to receive a multicarrier advertisement message from a base station, the multicarrier advertisement message including information related to multicarrier configuration supported by the base station; and
a controller configured to control the wireless communication unit to determine carriers simultaneously available in the terminal based upon the multicarrier configuration information, send a first message to the base station to request for carrier assignment, and receive a second message, including information related to carriers assigned to the terminal, from the base station.

16. The apparatus of claim 15, wherein the first message is one of a multicarrier request message, a multicarrier request extended header or a multicarrier request signaling header.

17. The apparatus of claim 15, wherein the first message comprises information indicating whether or not all the carriers supported by the base station are available.

18. The apparatus of claim 15, wherein the second message is one of a multicarrier response message, a multicarrier response extended header or a multicarrier response signaling header. formation indicating whether or not all the carriers requested by the terminal have been assigned.
